(19) United States
(12) Patent Application Publication
(10) Pub. No.: US 2021/0001816 A1
(43) Pub. Date: Jan. 7, 2021

(54) CLEANER-EQUIPPED SENSOR SYSTEM FOR VEHICLE

(71) Applicant: KOITO MANUFACTURING CO., LTD., Tokyo (JP)

(72) Inventors: Akinobu KUBOTA, Shizuoka-shi, Shizuoka (JP); Kazuki KAWAMURA, Shizuoka-shi, Shizuoka (JP)

(73) Assignee: KOITO MANUFACTURING CO., LTD., Tokyo (JP)

(21) Appl. No.: 16/977,559

(22) PCT Filed: Mar. 7, 2019
(86) PCT No.: PCT/JP2019/009047

§ 371 Date: Sep. 2, 2020

(30) Foreign Application Priority Data
Mar. 7, 2018 (JP) 2018-041039

(51) Int. Cl. B60S 1/48; G01S 7/497; B60S 1/54

(52) U.S. Cl. CPC B60S 1/481; G01S 2007/4977; B60S 1/54; G01S 7/497

(57) ABSTRACT

A cleaner-equipped sensor system for a vehicle includes: an external sensor capable of acquiring information on an outside of a vehicle; a cleaner unit including a liquid cleaner capable of discharging a cleaning liquid toward the external sensor, and an air cleaner capable of discharging air toward the external sensor; and an electronic processing device configured to output an output of the external sensor to a vehicle control unit controlling the vehicle, and to control the cleaner unit depending on an output of the vehicle control unit. The external sensor and the electronic processing device are integrated.

### TECHNICAL FIELD

The present invention relates to a cleaner-equipped sensor system for a vehicle.

### BACKGROUND ART

In recent years, the number of vehicles equipped with in-vehicle cameras that image situations around a vehicle is increasing. A lens of the in-vehicle camera, which is an imaging surface, may become dirty due to rain, mud and the like. Therefore, Patent Literature 1 discloses a cleaner for removing foreign substances by blowing a cleaning liquid, compressed air, and the like to a lens of an in-vehicle camera in order to remove foreign substances such as water droplets adhering to the lens.

For example, Patent Literature 1 proposes a configuration in which a compressed air generation unit is installed in a vicinity of the in-vehicle camera, compressed air of the compressed air generation unit is jetted from a nozzle, high-pressure air is blown to front glass of the in-vehicle camera, and thus water droplets adhering to the front glass are removed.

### CITATION LIST

### Patent Literature

Patent Literature 1: JP-A-2001-171491

### SUMMARY OF INVENTION

### Technical Problem

In Patent Literature 1, when a wiper is operated, an in-vehicle switch is operated at the same time to blow water or compressed air onto the front glass. Since an ECU (vehicle control unit) that controls an operation of the vehicle also controls an operation of the wiper, it is considered to be reasonable that the cleaner is also controlled by the vehicle control unit. However, it has been found that there is a room for improvement in the cleaner having such a configuration.

An object of the present invention is to provide a cleaner-equipped sensor system having a configuration different from that of Patent Literature 1.

### Solution to Problem

In order to achieve the above object, a cleaner-equipped sensor system according to an aspect of the present invention includes:

an external sensor capable of acquiring information on an outside of a vehicle;

a cleaner unit including a liquid cleaner capable of discharging a cleaning liquid toward the external sensor, and an air cleaner capable of discharging air toward the external sensor; and

an electronic processing device configured to output an output of the external sensor to a vehicle control unit for controlling the vehicle and control the cleaner unit depending on an output of the vehicle control unit, wherein

the external sensor and the electronic processing device are integrated.

According to the present invention, a cleaner-equipped sensor system having a configuration different from that of Patent Literature 1 is provided.

### BRIEF DESCRIPTION OF DRAWINGS

FIG. 1 is a perspective view showing a rear portion of a vehicle including a sensor system according to an embodiment of the present invention.

FIG. 2 is a front view showing the sensor system.

FIG. 3 is a top view showing the sensor system.

FIG. 4 is a schematic view showing an inside of a first air pump.

FIG. 5 is an exploded perspective view of a second air pump.

FIG. 6 is a block diagram of the sensor system.

### DESCRIPTION OF EMBODIMENTS

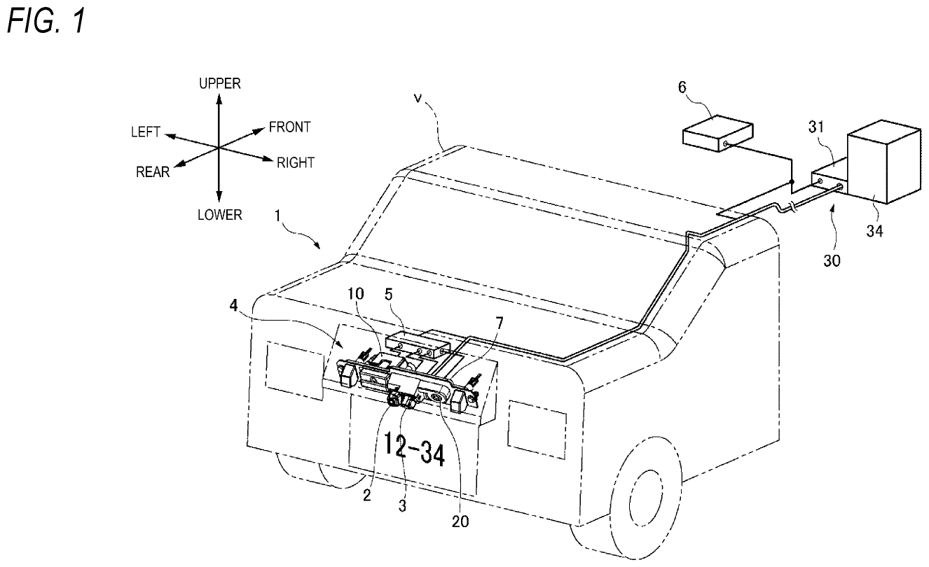

A cleaner-equipped sensor system 1 for a vehicle (hereinafter, simply referred to as a sensor system 1) according to an embodiment of the present invention will be described with reference to the drawings. FIG. 1 is a schematic view showing a vehicle V to which the sensor system 1 is attached. As illustrated in FIG. 1, the sensor system 1 of the present embodiment is applied to a configuration including a rear camera 2 (an example of external sensors 2, 3) and a back camera 3 (another example of the external sensors 2, 3) that acquire information of a rear of the vehicle V.

As illustrated in FIG. 1, the sensor system 1 includes the rear camera 2, the back camera 3, a cleaner unit 4, and a sensor control unit 5.

The rear camera 2 always acquires an image of the rear of the vehicle V. The rear camera 2 always acquires an image of the rear of the vehicle V at a relatively wide angle of view. For example, information output from the rear camera 2 can be used to confirm whether there is another vehicle attempting to overtake the host vehicle V from behind.

The back camera 3 acquires an image of the rear of the vehicle V when the vehicle V moves backward. The back camera 3 acquires information near the host vehicle V at the time of backward movement. For example, information output from the back camera 3 can be used to confirm whether there is an obstacle near the host vehicle V, such as when trying to park.

The cleaner unit 4 cleans a lens of the rear camera 2 and a lens of the back camera 3. The cleaner unit 4 includes a first air cleaner 10, a second air cleaner 20, and a liquid cleaner 30.

The first air cleaner 10 discharges high-pressure air to an object to be cleaned instantaneously or intermittently during operation. For example, the first air cleaner 10 can be used to remove dust adhering to the lens.

The second air cleaner 20 continuously discharges air to an object to be cleaned during operation. For example, the second air cleaner 20 may be configured to be continuously operated so that dust does not adhere to the lens.

The liquid cleaner 30 discharges a cleaning liquid to an object to be cleaned instantaneously or intermittently during operation. For example, the liquid cleaner 30 can be used to remove heavy dirt such as mud from the object to be cleaned.

The first air cleaner 10, the second air cleaner 20, and the liquid cleaner 30 can be operated in combination. For example, the second air cleaner 20 can be operated after the liquid cleaner 30 is operated.

The rear camera 2, the back camera 3, the first air cleaner 10, the second air cleaner 20, the nozzle of the liquid cleaner 30, and the sensor control unit 5 are attached to a common attachment member 7 so as to be integrated.

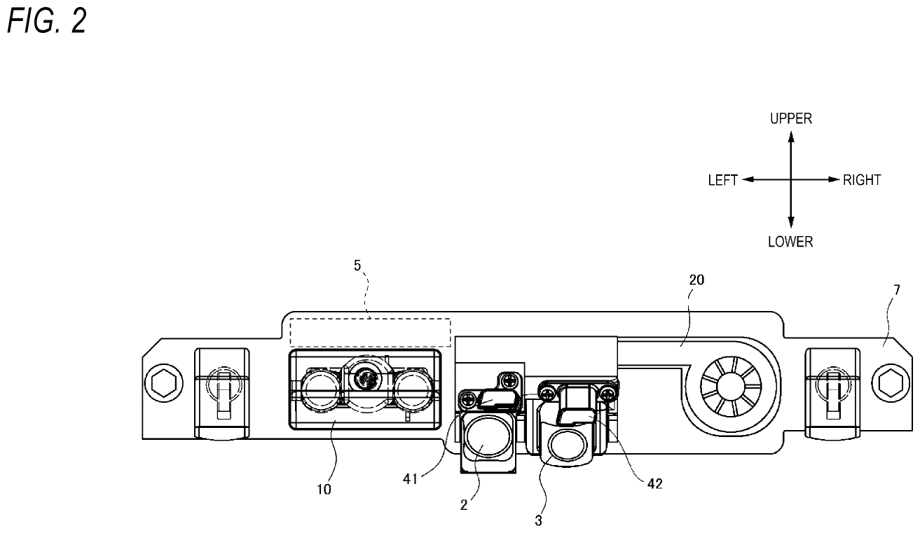

FIG. 2 is a front view of the attachment member 7 (a view as seen from a rear side of the vehicle to which the sensor system 1 is attached). As illustrated in FIG. 2, the lens of the rear camera 2 is exposed rearward. The lens of the back camera 3 is also exposed rearward. Nozzle portions 41, 42 are provided in an upper vicinity of the respective lens.

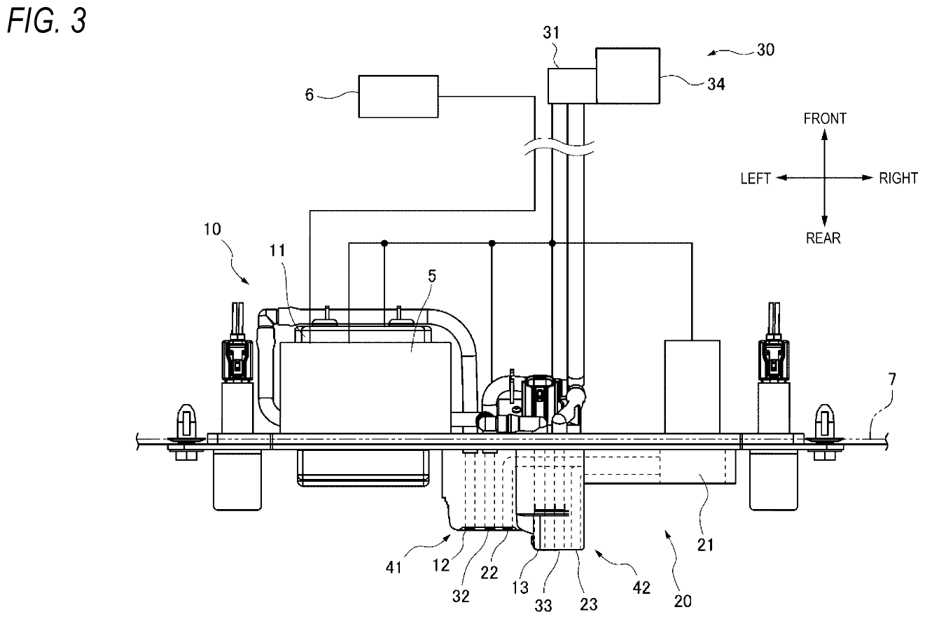

FIG. 3 is a schematic view of the attachment member 7 as seen from above (a schematic view as seen from above the vehicle V to which the sensor system 1 is attached). As illustrated in FIG. 3, the first air cleaner 10 includes a first high-pressure air generation unit 11, a first rear nozzle 12, a pipe line for guiding air from the first high-pressure air generation unit 11 to the first rear nozzle 12, a first back nozzle 13, and a pipe line for guiding air from the first high-pressure air generation unit 11 to the first back nozzle 13.

The second air cleaner 20 includes a second high-pressure air generation unit 21, a second rear nozzle 22, a pipe line for guiding air from the second high-pressure air generation unit 21 to the second rear nozzle 22, a second back nozzle 23, and a pipe line for guiding air from the second high-pressure air generation unit 21 to the second back nozzle 23. In the illustrated configuration, a part of the pipe line for guiding air from the second high-pressure air generation unit 21 to the second rear nozzle 22 and a part of the pipe line for guiding air from the second high-pressure air generation unit 21 to the second back nozzle 23 are made common.

The liquid cleaner 30 includes a third pump 31, a third rear nozzle 32, a pipe line for guiding air from the third pump 31 to the third rear nozzle 32, a third back nozzle 33, a pipe line for guiding air from the third pump 31 to the third back nozzle 33, and a tank 34 for storing the cleaning liquid. In the illustrated configuration, most of the pipe line for guiding air from the third pump 31 to the third rear nozzle 32 and most of the pipe line for guiding air from the third pump 31 to the third back nozzle 33 are made common.

The first rear nozzle 12, the second rear nozzle 22, and the third rear nozzle 32 are collectively accommodated in the rear nozzle portion 41. The first back nozzle 13, the second back nozzle 23, and the third back nozzle 33 are collectively accommodated in the back nozzle portion 42.

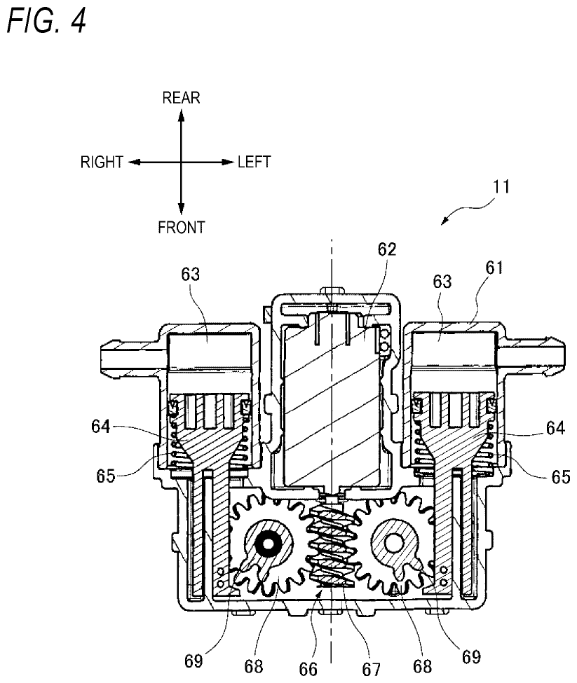

FIG. 4 is a schematic view showing an inside of the first high-pressure air generation unit 11.

The first high-pressure air generating unit 11 includes a first housing 61, a first motor 62, a pair of pump chambers 63, pistons 64 respectively provided in the pump chambers 63, biasing means 65 respectively provided on the pistons 64, and a power transmission mechanism 66. The biasing means 65 biases the piston 64 in a direction in which an internal volume of the pump chamber 63 reduces. The power transmission mechanism 66 is a mechanism for converting rotational motion of an output shaft of the first motor 62 into reciprocating motion of the piston 64. The power transmission mechanism 66 includes a worm gear 67 fixed to the output shaft, gears 68 that mesh with the worm gear 67, and intermittent gears 69 that rotates coaxially with the gears 68.

When the output shaft of the first motor 62 rotates, the power transmission mechanism 66 displaces the piston 64 in a direction in which the internal volume of the pump chamber 63 increases. At this time, the first motor 62 displaces the piston 64 in a direction opposite to a biasing force of the biasing means 65 against the biasing force. When a displacement amount of the piston 64 is constant, the intermittent gear 69 and the piston 64 are disengaged, and the power transmission mechanism 66 does not transmit power to the piston 64. Then, an elastic restoring force of the biasing means 65 acts on the piston 64, the piston 64 is displaced in a direction in which the internal volume of the pump chamber 63 is reduced vigorously, and high-pressure air is sent out from each pump chamber 63 to each pipe line.

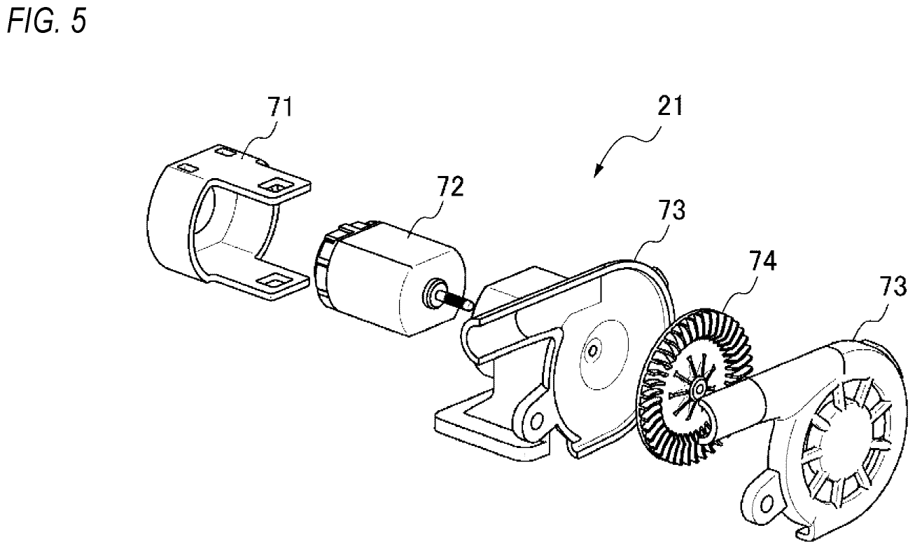

FIG. 5 is an exploded perspective view of a part of the second high-pressure air generation unit 21. As illustrated in FIG. 5, the high-pressure air generation unit 21 includes a motor case 71, a second motor 72, a second housing 73, and an impeller 74. The second air cleaner 20 is a so-called blower. The impeller 74 is rotatably provided inside the second housing 73. A pipe line is formed inside the second housing 73. The impeller 74 is fixed to an output shaft of the second motor 72. When the second motor 72 is driven, the impeller 74 rotates, and air sent by the impeller 74 is sent out to the pipe line inside the second housing 73.

Since a known cleaner for discharging a cleaning liquid can be used for the liquid cleaner 30, a detailed description thereof will be omitted. The third pump 31 pumps the cleaning liquid stored in the tank 34 to discharge the cleaning liquid from the third rear nozzle 32 and the third back nozzle 33.

With reference to FIG. 3 again, the sensor control unit 5 (electronic processing device) is fixed to the attachment member 7 together with the first high-pressure air generation unit 11, the first rear nozzle 12, the first back nozzle 13, the second high-pressure air generation unit 21, the second rear nozzle 22, the second back nozzle 23, the third rear nozzle 32, the third back nozzle 33, the rear camera 2, and the back camera 3, and the sensor control unit 5 is integrated with these members. In FIG. 1, the sensor control unit 5 is illustrated in a state where the sensor control unit 5 is detached from the attachment member 7 for easy understanding.

The first motor 62 of the first air cleaner 10, the second motor 72 of the second air cleaner 29, the third pump 31 of the liquid cleaner 30, an imaging element 2a of the rear camera 2, and an imaging element 3a of the back camera 3 are connected to the sensor control unit 5. The sensor control unit 5 is also connected to a vehicle control unit 6. The sensor control unit 5 outputs signals output from the rear camera 2 and the back camera 3 to the vehicle control unit 6. The sensor control unit 5 controls operations of the first motor 62 of the first air cleaner 10, the second motor 72 of the second air cleaner 20, and the third pump 31 of the liquid cleaner 30 depending on an output from the vehicle control unit 6.

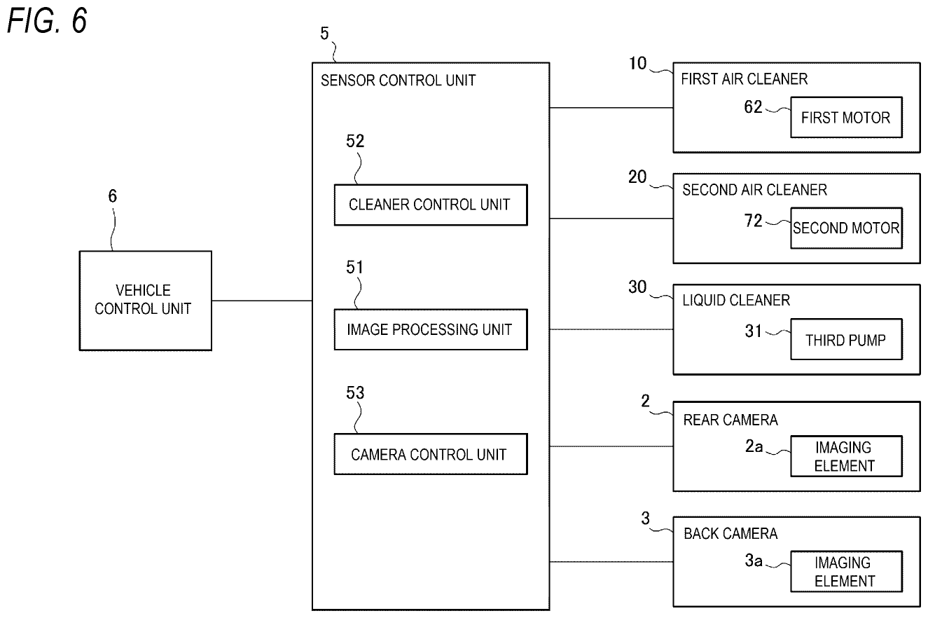

FIG. 6 is a block diagram of the cleaner-equipped sensor system 1 according to the present embodiment. As illustrated in FIG. 6, the sensor control unit 5 includes an image processing unit 51 and a cleaner control unit 52.

The image processing unit 51 outputs the outputs of the rear camera 2 and the back camera 3 to the vehicle control unit 6.

The outputs of the rear camera 2 and the back camera 3 are analog signals output from the imaging element 2a of the rear camera 2 and the imaging element 3a of the back camera 3, for example. The image processing unit 51 acquires the analog signals and converts the analog signals into digital signals, and outputs the digital signals to the vehicle control unit 6.

Alternatively, the outputs of the rear camera 2 and the back camera 3 are digital signals obtained by converting analog signals output from the imaging elements 2a, 3a by an A/D converter, for example. The image processing unit 51 acquires the digital signal (for example, raw data), converts the digital signal into a digital signal having a smaller data amount (for example, JPEG data or MPEG data), and outputs the digital signal to the vehicle control unit 6.

The cleaner control unit 52 controls the first motor 62, the second motor 72, and the third pump 31. The cleaner control unit 52 controls the first motor 62, the second motor 72, and the third pump 31 depending on a signal output from the vehicle control unit 6. For example, when a signal for causing the first air cleaner 10 to operate is input from the vehicle control unit 6, the cleaner control unit 52 supplies predetermined electric power to the first motor 62.

The cleaner control unit 52 may be configured to supply electric power to each motor, or may be configured to output a command value indicating the electric power to be supplied to each motor to an electronic circuit provided in a vicinity of the motor.

Alternatively, the image processing unit 51 and the cleaner control unit 52 may be configured to be able to detect whether or not dirt adheres to the cameras 2, 3 based on signals acquired from the rear camera 2 and the back camera 3 or signals subjected to image processing. For example, the image processing unit 51 or the cleaner control unit 52 can be configured to, when pixels in the same region output the same intensity signals for a certain period of time, determine that dirt is attached to a lens corresponding to the region.

The cleaner control unit 52 may be configured to control the first motor 62, the second motor 72, and the third pump 31 depending on a signal output from the image processing unit 51. For example, in a case where the image processing unit 51 is configured to be able to detect dirt of the rear camera 2 or the back camera 3 based on a signal subjected to image processing, when the image processing unit 51 detects dirt, the cleaner control unit 52 may be configured to supply predetermined electric power to the third pump 31 and further supply predetermined power to the first motor 62. Alternatively, an amount of electric power to be supplied to the third pump 31 may be calculated depending on a size of the dirt, and the amount of electric power may be supplied to the third pump 31.

Alternatively, the cleaner control unit 52 may be configured to change an operation mode of the cleaner unit 4 depending on a signal output from the vehicle control unit 6. For example, a mode in which the cleaning liquid is intermittently discharged three times and a mode in which the cleaning liquid is intermittently discharged five times may be switched depending on a vehicle speed output by the vehicle control unit 6.

The sensor control unit 5 may include a camera control unit 53. The camera control unit 53 controls the rear camera 2 and the back camera 3. For example, the camera control unit 53 changes a frame rate of the rear camera 2 depending on a signal representing a vehicle speed output from the vehicle control unit 6. Alternatively, the camera control unit 53 changes a shutter speed of the back camera 3 depending on a signal representing ambient brightness output from the vehicle control unit 6.

The sensor control unit 5 may be configured with a single electronic circuit. Alternatively, an electronic circuit functioning as the cleaner control unit 52 and an electronic circuit functioning as the image processing unit 51 may be accommodated in a common casing. Alternatively, the electronic circuits respectively functioning as the cleaner control unit 52 and the image processing unit 51 may be mounted on a common substrate.

With the sensor system 1 according to the present embodiment, the sensor control unit 5 that outputs the outputs of the external sensors 2, 3 to the vehicle control unit 6 and controls the cleaner unit 4 depending on the output of the vehicle control unit 6 is integrated with the external sensors 2, 3. The cleaner unit 4 that cleans the external sensors 2, 3 and the external sensors 2, 3 are provided at positions close to each other. As in the present embodiment, when the sensor control unit 5 that controls the cleaner unit 4 is integrated with the external sensors 2, 3, the external sensors 2, 3 and the sensor control unit 5 are also provided at positions close to each other, so that a wiring between the cleaner unit 4 and the sensor control unit 5 is also likely to be shortened. In the present embodiment, at least a wiring between the first motor 62 and the sensor control unit 5 can be set to be shorter than a wiring between the vehicle control unit 6 and the sensor control unit 5. A wiring between the second motor 72 and the sensor control unit 5 can be set to be shorter than the wiring between the vehicle control unit 6 and the sensor control unit 5.

Unlike the present embodiment, in a case where the vehicle control unit controls the cleaner unit, it is necessary to provide wirings between the vehicle control unit and the respective cleaner units, and a total length of all the wirings increases. As compared to such a configuration, according to the sensor system 1 of the present embodiment, the total length of all the wirings is likely to be shortened.

Further, unlike the present embodiment, in a case where electronic circuits functioning as the cleaner control unit and the image processing unit are provided in a distributed manner, the respective electronic circuits may be protected by waterproof covers, and a size of the entire sensor system is likely to increase. However, according to the present embodiment, since the electronic circuits functioning as the cleaner control unit 52, the image processing unit 51, and the camera control unit 53 are collectively configured as the sensor control unit 5, the size of the entire sensor system 1 is less likely to increase even if the sensor control unit 5 is protected by a waterproof cover.

(Various Modifications)

In the embodiment described above, a configuration in which the external sensors and the sensor control unit are attached to a common attachment member and are integrated has been described, but the present invention is not limited thereto. A sensor control unit may be provided inside a housing of the external sensors. The sensor control unit may be provided integrally with the housing of the external sensors.

In the embodiment described above, an example in which the rear camera and the back camera are applied as external sensors has been described, but the present invention is not limited thereto. For example, as external sensors, a front camera that acquires information of the front of the host vehicle, a right camera that acquires information of a right side of the host vehicle, a left camera that acquires information of a left side of the host vehicle, a front LiDAR that acquires information of the front of the host vehicle, a right LiDAR that acquires information of the right side of the host vehicle, a left LiDAR that acquires information of the left side of the host vehicle, a rear LiDAR that acquires information of the rear of the host vehicle, a front radar that acquires information of the front of the host vehicle, a right radar that acquires information of the right side of the host vehicle, a left radar that acquires information of the left side of the host vehicle, a rear radar that acquires information of the rear of the host vehicle, and the like can be applied.

The LiDAR is generally a sensor that emits non-visible light forward and acquires information such as a distance to an object, a shape of an object, a material of an object, and the like based on the emitted light and return light. The LiDAR generally includes a light emitting unit that emits infrared rays or near-infrared rays, a light receiving unit that receives the light, a filter through which only infrared rays or near-infrared rays pass, a transparent cover through which light passes, and a housing that houses these parts. The LiDAR may include another lens and a cover for protecting the lens. In some cases, the transparent cover, the filter, the lens, and the like are integrated.

In the embodiment described above, an example in which the cleaner unit cleans the lens of the camera has been described, but the cleaner unit may be configured to clean the transparent cover, the filter, or the like.

The sensor system may include two or more external sensors having different operating principles, such as a front camera and a front LiDAR.

In the embodiment described above, a configuration in which the air and the cleaning liquid sent from the first high-pressure air generation unit, the second high-pressure air generation unit, and the third pump are discharged to both the lens of the rear camera and the lens of the back camera has been described, but the present invention is not limited thereto. For example, an electromagnetic valve and the like may be provided in each pipe line, and the air may be discharged only to the lens of the rear camera during operation of the first high-pressure air generation unit, and is not discharged to the lens of the back camera by opening and closing the valve.

Alternatively, the sensor system may include both a rear air cleaner configured to send air only to the rear camera and not to the back camera and a back air cleaner configured to send air only to the back camera and not to the rear camera.

In the embodiment described above, an example in which a volumetric first air cleaner is adopted and a non-volumetric blower is adopted as the second air cleaner has been described, but the present invention is not limited thereto. As the air cleaner, a known pump, a compressor, or a blower having a configuration other than the configuration of the embodiment described above can be adopted. In the embodiment described above, an example in which the sensor system includes two air cleaners has been described, but the present invention is not limited thereto. The sensor system may include a single air cleaner, or may include three or more air cleaners.

The present application is based on a Japanese Patent Application No. 2018-041039 filed on Mar. 7, 2018, the contents of which are incorporated herein by reference.

### INDUSTRIAL APPLICABILITY

According to the present invention, a cleaner-equipped sensor system having a configuration different from that of Patent Literature 1 is provided.

### REFERENCE SIGNS LIST

1 cleaner-equipped sensor system
2 rear camera (external sensor)
2a, 3a imaging element
3 back camera (external sensor)
4 cleaner unit
5 sensor control unit (electronic processing device)
6 vehicle control unit
7 attachment member
10 first air cleaner
11 first high-pressure air generation unit
12 first rear nozzle
13 first back nozzle
20 second air cleaner
21 second high-pressure air generation unit
22 second rear nozzle
23 second back nozzle
30 liquid cleaner
31 third pump
32 third rear nozzle
33 third back nozzle
34 tank
41 rear nozzle portion
42 back nozzle portion
51 image processing unit
52 cleaner control unit
53 camera control unit
61 first housing
62 first motor
63 pump chamber
64 piston
65 biasing means
66 power transmission mechanism
67 worm gear
68 gear
69 intermittent gear
71 motor case
72 second motor
73 second housing
74 impeller
V vehicle

1. A cleaner-equipped sensor system for a vehicle, comprising:
an external sensor capable of acquiring information on an outside of a vehicle;
a cleaner unit including a liquid cleaner capable of discharging a cleaning liquid toward the external sensor, and an air cleaner capable of discharging air toward the external sensor; and
an electronic processing device configured to output an output of the external sensor to a vehicle control unit controlling the vehicle, and to control the cleaner unit depending on an output of the vehicle control unit, wherein
the external sensor and the electronic processing device are integrated.

2. The cleaner-equipped sensor system according to claim 1, wherein
the external sensor and the electronic processing device are attached to a common attachment member so as to be integrated.

3. The cleaner-equipped sensor system according to claim 1, wherein
a wiring connecting the external sensor and the electronic processing device is shorter than a wiring connecting the vehicle control unit and the electronic processing device.

4. The cleaner-equipped sensor system according to claim 1, wherein
the electronic processing device is configured to operate the air cleaner after operating the liquid cleaner.

5. The cleaner-equipped sensor system according to claim 1, wherein
the electronic processing device is configured to operate the cleaner unit depending on an output of the vehicle control unit.

6. The cleaner-equipped sensor system according to claim 1, wherein
the electronic processing device is configured to change an operation mode of the cleaner unit depending on an output of the vehicle control unit.

7. The cleaner-equipped sensor system according to claim 1, wherein
at least a part of the cleaner unit is integrated with the external sensor and the electronic processing device.
